(19) United States
(12) Patent Application Publication
(10) Pub. No.: US 2022/0250102 A1
(43) Pub. Date: Aug. 11, 2022

(54) SPRAY IONIZATION DEVICE, ANALYSIS DEVICE, AND SURFACE COATING DEVICE

(71) Applicant: National Institute of Advanced Industrial Science and Technology, Tokyo (JP)

(72) Inventors: Shinichiro Fujii, Tsukuba-shi (JP); Kazumi Inagaki, Tsukuba-shi (JP); Shinichi Miyashita, Tsukuba-shi (JP)

(73) Assignee: National Institute of Advanced Industrial Science and Technology, Tokyo (JP)

(21) Appl. No.: 17/620,217

(22) PCT Filed: Jul. 17, 2020
(86) PCT No.: PCT/JP2020/027873

§ 371 Date: Dec. 17, 2021

(30) Foreign Application Priority Data
Jul. 31, 2019 (JP) 2019-141193

(51) Int. Cl. B05B 5/053; B05B 7/06; B05B 7/22; B05B 5/03

(52) U.S. Cl. CPC B05B 5/0533; B05B 5/03; B05B 7/22; B05B 7/06

(57) ABSTRACT

A spray ionization device is provided with: a first tube body having a first flow channel through which a first fluid can flow, and having, at one end thereof, a first outlet for spraying the first liquid; a second tube body having a second flow channel through which a second fluid can flow, and having, at one end thereof, a second outlet for spraying the second liquid; an outer tube that has a gas flow channel through which a gas can flow, the outer tube having, at one end thereof, a spray port that is covered with a porous member; and an electrode that is provided between the first flow channel, the second channel, and the first outlet or the second outlet and the porous member, the electrode allowing for a voltage to be applied to the first liquid and/or the second liquid by a power source.

### TECHNICAL FIELD

The present invention relates to a spray ionization device, an analysis device, and a surface coating device.

### BACKGROUND ART

A mass spectrometer can count ions constituting a substance by each mass-to-charge ratio to obtain ion intensity which is quantitative information on the substance. The mass spectrometer can perform a more accurate analysis by obtaining an ion intensity having a good signal-to-noise ratio. Therefore, an analysis target, which is an ionized or a charged material, needs to be sufficiently introduced.

Examples of a method of ionizing a liquid sample include an electrospray ionization method. With the electrospray ionization method, high voltage of several kilovolts is applied to a sample solution in a narrow tube, a liquid cone (so-called Taylor cone) is formed at the tip of an outlet. Electrically charged droplets are ejected from the tip of the liquid cone, solvents evaporate to reduce the volume of the electrically charged droplets, and the electrically charged droplets finally split apart to generate gas-phase ions. This method can form electrically charged droplets at a rate of ejecting 1 to 10 μL/min of solution, in which the eject rate is not sufficient for use in conjunction with a liquid chromatography method.

A gas spray assisted electrospray ionization method (see, for example, U.S. Pat. No. 8,809,777) may be an example of a method for supporting generation of electrically charged droplets and vaporization of solvents by ejecting a gas from an outer tube surrounding a narrow tube of a sample solution, in order to promote vaporization of electrically charged droplets.

Patent Document 1: U.S. Pat. No. 8,809,777, Specification

### DISCLOSURE OF THE INVENTION

### Problems to be Solved by the Invention

However, with the gas spray assisted electrospray ionization method as disclosed in U.S. Pat. No. 8,809,777, it is difficult to stably form charged droplets in which a plurality of sample liquids are mixed, which has been a problem.

An object of the present invention is to solve the aforementioned problem and provide a spray ionization device capable of stably forming charged droplets in which a plurality of sample liquids are mixed, and an analysis device and a surface coating device including the same.

### Means for Solving the Problems

One aspect of the present invention provides a spray ionization device, including: a first tube including a first channel through which a first liquid can flow, the first tube including a first outlet for ejecting the first liquid at one end; a second tube including a second channel through which a second liquid can flow, the second tube including a second outlet for ejecting the second liquid at the one end; an outer tube including the first tube and the second tube, the outer tube surrounding an outer circumferential surface of at least one of the first tube and the second tube with a gap, the outer tube including a gas channel through which a gas can flow, the outer tube including an ejection port covered with a porous member at a distance downstream of the first outlet and the second outlet at the one end; and an electrode arranged between the first channel, the second channel and the first outlet, and the porous member, or between the first channel, the second channel and the second outlet, and the porous member, the electrode being capable of applying voltage to at least one of the first liquid and the second liquid by a power source connected to the electrode, in which charged droplets generated by mixing the first liquid and the second liquid together with the gas can be ejected from the ejection port.

According to the above aspect, voltage is applied to at least one of the first liquid and the second liquid, and the first liquid and the second liquid ejected from the first outlet and the second outlet, respectively, and the gas from the gas channel collide with the non-opening of the porous member to form a turbulent flow state. As a result, electrically charged droplets, in which the first liquid and the second liquid are mixed, are formed, and the charged droplets are introduced from the opening of the porous member and ejected from the ejection port. The first liquid and the second liquid, at least one of which is charged, are mixed immediately after being ejected and form electrically charged droplets, whereby the spray ionization device capable of stably ejecting charged droplets can be provided. In the case in which a chemical reaction takes place between the first liquid and the second liquid, the liquids can be introduced into the analysis device immediately after the chemical reaction takes place by mixing by ejection, whereby the spray ionization device capable of forming droplets allowing for accurately analyzing the reactant can be provided. In the case in which the first liquid is difficult to electrically charge as it is, the second liquid is electrically charged by applying voltage to the second liquid, whereby the spray ionization device capable of forming mixed droplets of the first liquid and the second liquid, which are electrically charged, can be provided.

One other aspect of the present invention provides an analysis device, including: the spray ionization device of the aspect described above; and an analysis unit that introduces and analyzes the electrically charged droplets sprayed from the spray ionization device.

According to the other aspect, the spray ionization device achieves various operational effects of the aspect, whereby the analysis device capable of performing analysis characterized by the operational effects can be provided.

### BRIEF DESCRIPTION OF THE DRAWINGS

FIG. 1 is a diagram schematically illustrating a configuration of a spray ionization device according to a first embodiment of the present invention;

FIGS. 2A and 2B are cross-sectional views of a nozzle of a sprayer according to the first embodiment of the present invention;

FIGS. 3A and 3B are cross-sectional views schematically illustrating a configuration of an electrode;

FIG. 4 is a view of a nozzle observed from downstream of an ejection port;

FIG. 5 is a cross-sectional view schematically illustrating a configuration of another variation of the electrode;

FIGS. 6A and 6B are cross-sectional views of the nozzle of a first variation of the sprayer according to the first embodiment of the present invention;

FIG. 7 is a cross-sectional view of the nozzle of a second variation of the sprayer according to the first embodiment of the present invention;

FIG. 8 is a diagram schematically illustrating a configuration of a spray ionization device according to a second embodiment of the present invention;

FIG. 9 is a diagram schematically illustrating a configuration of a spray ionization device according to a third embodiment of the present invention;

FIG. 10 is a diagram schematically illustrating a configuration of an analysis device according to an embodiment of the present invention;

FIG. 11A is a diagram illustrating an example of a mass chromatogram of Example 1;

FIG. 11B is a diagram illustrating an example of a mass chromatogram of Comparative Example 1;

FIG. 12 is a diagram illustrating measurement examples of signal intensity of Examples 1 and 2 and Comparative Example 1; and

FIG. 13 is a diagram illustrating another measurement example of signal intensity of Examples 3 and 4 and Comparative Example 2.

### PREFERRED MODE FOR CARRYING OUT THE INVENTION

Hereinafter, embodiments of the present invention will be described with reference to the drawings. Note that elements that are common between a plurality of drawings are denoted by the same reference characters, and detailed description of such elements will not be repeated.

### First Embodiment

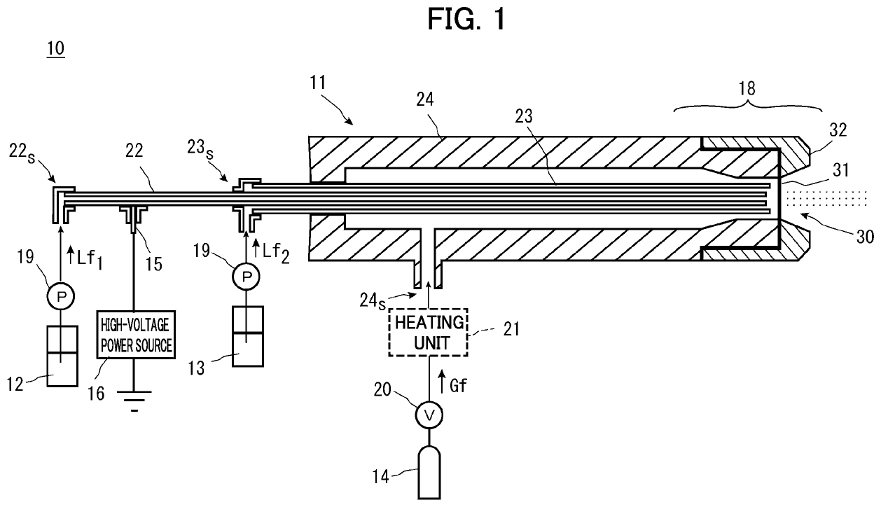

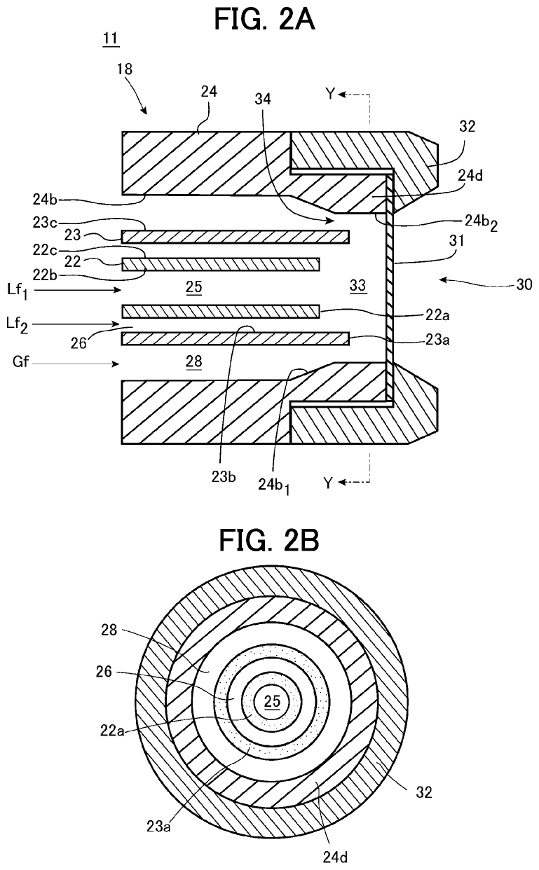

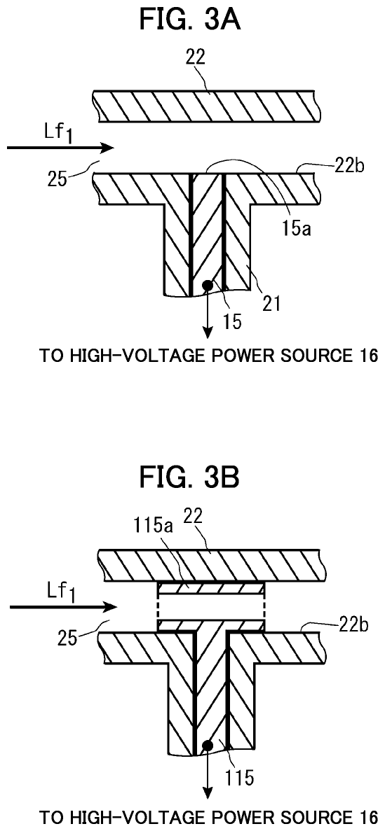

FIG. 1 is a diagram schematically illustrating a configuration of a spray ionization device according to a first embodiment of the present invention. FIG. 2A is an enlarged cross-sectional view of a nozzle of a sprayer along the longitudinal direction of the sprayer. FIG. 2B is a view along arrows Y-Y in FIG. 2A. FIGS. 3A and 3B are cross-sectional views schematically illustrating a configuration of an electrode.

Referring to FIGS. 1 to 3B, a spray ionization device 10 according to a first embodiment of the present invention includes: a sprayer 11; containers 12 and 13 containing sample liquids Lf₁ and Lf₂, respectively, to be supplied to the sprayer 11; a cylinder 14 for containing a spraying gas Gf to be supplied to the sprayer 11; and a high-voltage power source 16 for applying high voltage to the sample liquid Lf₁ via an electrode 15. A nozzle 18 for ejecting electrically charged droplets is formed at one end (hereinafter also referred to as an ejection end) of the sprayer 11 of the spray ionization device 10.

The sample liquids Lf₁ and Lf₂ and the spraying gas Gf are supplied from further toward the opposite end than the nozzle 18 (hereinafter also referred to as a supply end) of the sprayer 11. The sample liquids Lf₁ and Lf₂ are supplied from supply ports 22ₛ and 23ₛ from the containers 12 and 13, respectively, by way of a pump 19 and the like. The sample liquids Lf₁ and Lf₂ may be continuously or intermittently supplied. The sample liquids Lf₁ and Lf₂ may contain an analysis target in solvents, or may contain dissolved components, particulate matter, or the like, for example. The spraying gas Gf is supplied from the cylinder 14 through the valve 20 to the supply port 24ₛ. Inert gas such as nitrogen gas or argon gas, or air can be used for the spraying gas Gf, for example. A heating unit 21 such as a heater or dryer for heating the spraying gas Gf may be provided between the cylinder 14 or the valve 20 and the supply port 24ₛ. The spraying gas Gf is heated, whereby vaporization of solvents in the ejected sample liquids Lf₁ and Lf₂ can be promoted, and electrically charged droplets can be obtained more efficiently.

The sprayer 11 includes: a first liquid supply tube 22, a second liquid supply tube 23 surrounding the first liquid supply tube 22 with a gap; and a gas supply tube 24 surrounding the second liquid supply tube 23 with a gap. Sprayer 11 has a triple tube structure including the first liquid supply tube 22 on the inner side, the second liquid supply tube 23 on the outer side, and the gas supply tube 24. The first liquid supply tube 22, the second liquid supply tube 23, and gas supply tube 24 are preferably coaxial with each other.

A tubular first channel 25 is defined on an inner circumferential surface 22b of the first liquid supply tube 22. The first liquid supply tube 22 has an outlet 22a, in the nozzle 18. The sample liquid Lf₁ is supplied from the supply port 22ₛ of the first liquid supply tube 22, flows through the first channel 25, and is ejected from the outlet 22a. The first liquid supply tube 22 may be, for example, a straight tube. A diameter (inner diameter) of the inner circumferential surface 22b is preferably 10 μm to 250 μm, and a diameter (outer diameter) of the outer circumferential surface 22c is preferably 100 μm to 500 μm.

The inner circumferential surface 23b of the second liquid supply tube 23 and the outer circumferential surface 22c of the first liquid supply tube 22 define a second channel 26. The second liquid supply tube 23 has an outlet 23a, in the nozzle 18. The sample liquid Lf₂ is supplied from the supply port 23ₛ of the second liquid supply tube 23, flows through the second channel 26, and is ejected from the outlet 23a. The second liquid supply tube 23 may be, for example, a straight tube. A diameter (inner diameter) of the inner circumferential surface 23b is preferably 200 μm to 700 μm, and a diameter (outer diameter) of the outer circumferential surface 23c is preferably 300 μm to 800 μm.

The first liquid supply tube 22 and the second liquid supply tube 23 may be formed of a dielectric material made of glass and plastics. An electrode 15 as described later is provided to at least one of the first liquid supply tube 22 and the second liquid supply tube 23. As a variation of the electrode, part of at least one of the first liquid supply tube 22 and the second liquid supply tube 23 may be made of an electrical conductor material to form the electrode 15. Entirety of at least one of the first liquid supply tube 22 and the second liquid supply tube 23 may be made of an electrical conductor material, e.g., a metal tube such as stainless steel, to form the electrode 15.

The inner circumferential surface 24b of the gas supply tube 24 and the outer circumferential surface 23c of the second liquid supply tube 23 define the gas channel 28. The gas supply tube 24 includes an opening 24b₂, in the nozzle 18. A diameter (inner diameter) of the inner circumferential surface 24b of the gas supply tube 24 is not limited in particular, and is, for example, 4 mm, further toward the supply end than the nozzle 18.

The gas supply tube 24 is preferably made of a dielectric material such as glass or plastics, and further preferably made of polyether ether ketone resin (PEEK resin).

The pressurized spraying gas Gf is supplied from the supply port 24ₛ of the gas supply tube 24, flows through the gas channel 28, and is ejected from a gap between the outlet 23a of the second liquid supply tube 23 and the gas supply tube 24. A flow rate of the spraying gas Gf is appropriately set in accordance with the flow rate of the sample liquids Lf₁ and Lf₂, and is set to 0.5 L/min to 5.0 L/min, for example.

High-voltage power source 16 is a high-voltage DC or high-frequency alternating-current voltage capable power supply. The high-voltage power source 16 is connected to the electrode 15 arranged so as to be able to contact the sample liquid Lf₁ flowing through the sprayer 11. The high-voltage power source 16 applies voltage of e.g., 4.0 kV to the electrode 15, and preferably applies voltage in a range of 0.5 kV to 10.0 kV in terms of ionization. In the case in which the high-voltage power source 16 generates high-frequency alternating-current voltage, the waveform of the alternating-current voltage is not limited in particular, and is a sine wave, a rectangular wave, or the like. In the case of ionization utilizing a chemical reaction, the frequency of the alternating-current voltage is preferably 100 Hz to 1000 kHz.

As illustrated in FIG. 1, the electrode 15 is provided further toward the supply end than the outlet 22a of the first liquid supply tube 22. As illustrated in FIG. 3A, the electrode 15 is formed so as to be able to contact the sample liquid Lf₁ flowing through the first channel 25. A tip 15a of the electrode 15 may be provided so as to form a surface contiguous with the inner circumferential surface 22b of the first liquid supply tube 22, or may be provided so as to project into the first channel 25. As long as the tip 15a of the electrode 15 can contact the sample liquid Lf₁, the tip 15a may be provided so as to recede from the inner circumferential surface 22b of the first liquid supply tube 22.

As a variation of the electrode 15 illustrated in FIG. 3B, the electrode 115 may include an annular member 115a in the first channel 25. The sample liquid Lf₁ can flow through the inside the annular member 115a. As a result, high voltage can be more easily applied to the sample liquid Lf₁. The electrode 15 or 115 is preferably made of a platinum-group element, gold, or alloy thereof, in terms of excellent corrosion resistance. The electrode 15 or 115 may be made of a metal material such as titanium, tungsten, or stainless steel which may be used for a common electrode. As described above, part or entirety of the first liquid supply tube 22 may be made of an electrical conductor material to form the electrode 15. For example, the outlet 22a of the liquid supply tube 22 may be made of an electrical conductor material to form the electrode 15.

In the case in which the electrode 15 is formed so as to be able to contact the sample liquid Lf₂ flowing through the second channel 26 of the second liquid supply tube 23, the electrode 15 may be formed in substantially the same manner as the configuration illustrated in FIGS. 3A and 3B, and may be provided further toward the ejection end than the supply port 23ₛ of the sample liquid Lf₂.

An ejection port 30 is provided to the gas supply tube 24, in the nozzle 18.

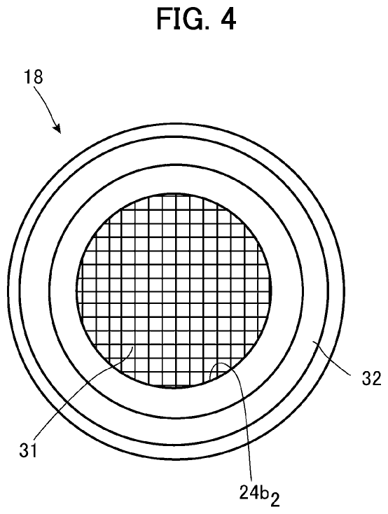

FIG. 4 illustrates a view of the nozzle observed from downstream of the ejection port. Referring to FIG. 4 together with FIGS. 2A and 2B, a porous member 31 is provided to the ejection port 30. The porous member 31 is sandwiched between the tip portion 24d of the gas supply tube 24 and a retaining member 32. The porous member 31 is arranged so as to cover the opening 24b₂ of the gas supply tube 24. The porous member 31 is a material having a multitude of openings, such as a porous film or a reticulated member, and can be, e.g., a film, a mesh sheet or the like, in which a multitude of openings are formed by microfabrication. A dielectric material can be used for the mesh sheet, and PEEK resin can be used therefor, for example. The mesh sheet has horizontal lines and vertical lines with an interval of 70 μm, for example, in which a vertical and horizontal size of each aperture is 35 μm, for example.

The porous member 31 is arranged at a gap downstream of the outlet 22a of the first liquid supply tube 22 and the outlet 23a of the second liquid supply tube 23. In this gap (also referred to as the “mixing region 33”), the electrically charged sample liquid Lf₁ ejected from outlet 22a of the first liquid supply tube 22, the sample liquid Lf₂ ejected from the outlet 23a of the second liquid supply tube 23, and the spraying gas Gf collide with a non-opening of the porous member 31 to form a turbulent flow state. As a result, the sample liquid Lf₁ and the sample liquid Lf₂ are atomized into droplets, and the electrically charged droplets of the sample liquid Lf₁ and the droplets of the sample liquid Lf₂ are combined to form electrically charged mixed droplets in a mixed state. Chemical reactions take place in the electrically charged mixed droplets, depending on the components of sample liquids Lf₁ and Lf₂.

A distance between the porous member 31 and the outlet 23a of the second liquid supply tube 23 is preferably 5 μm or more and 1000 μm or less, from a perspective that the electrically charged droplets of the sample liquid Lf₁ and the droplets of the sample liquid Lf₂ are mixed in the mixing region 33, electrically charged mixed droplets are sufficiently formed, and the droplets are atomized.

The outlet 23a of the second liquid supply tube 23 is preferably arranged at the same position as, or protrudes further downstream than, the outlet 22a of the first liquid supply tube 22 in the ejection direction, from a perspective that droplets of the sample liquid Lf₁ and droplets of the sample liquid Lf₂ can be easily mixed in the mixing region 33. In this case, a distance between the outlet 23a and the outlet 22a in the ejection direction is particularly preferably set between 0 μm and 1000 μm.

The electrically charged and atomized mixed droplets flow through the opening of the porous member 31 by way of the spraying gas Gf, and are ejected from the ejection port 30. The retaining member 32 may be formed at an angle so as to have a diameter that progressively increases downstream from the ejection port 30.

As illustrated in FIG. 2A, the channel area of the gas channel 28 preferably progressively decreases such that the diameter of the gas supply tube 24 progressively decreases in a portion 24b₁ of the inner circumferential surface from upstream toward downstream. A constriction portion 34 is preferably provided to the gas supply tube 24. The constriction portion 34 is arranged further upstream than the outlet 23a of the second liquid supply tube 23. As a result, the flow velocity of the spraying gas Gf increases, a turbulent state can be sufficiently created in the mixing region 33, atomization of droplets can be promoted. Here, the channel area is an area occupied by the gas channel 28 in a plane perpendicular to the longitudinal direction of sprayer 11, and is an area surrounded by the inner circumferential surface 24b of the gas supply tube 24 and the outer circumferential surface 23c of the second liquid supply tube 23 as illustrated in FIG. 2B. The constriction portion 34 is preferably provided 50 μm to 5000 μm upstream of the outlet 23a.

A distance between the portion 24b₁ of the inner circumferential surface of gas supply tube 24 and the outer circumferential surface 23c of the second liquid supply tube 23 is preferably set to 20 μm to 400 μm, in the constriction portion 34.

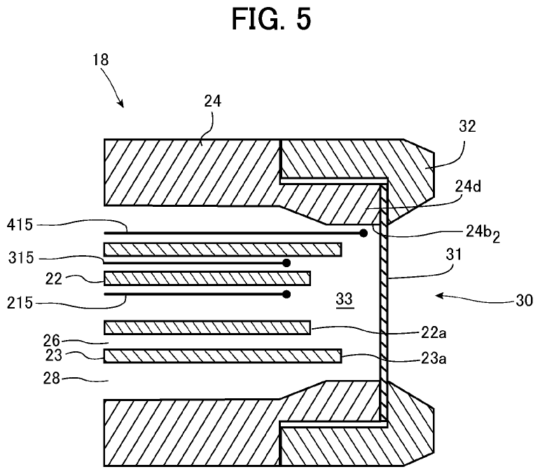

FIG. 5 is a cross-sectional view illustrating a schematic configuration of another variation of the electrode. Referring to FIG. 5, the electrode may be arranged so as to reach the nozzle 18 of the sprayer 11. For example, the electrode 215 may be arranged through the inside of the first channel 25 of the first liquid supply tube 22 to reach the outlet 22a of the liquid supply tube 22. The electrode 315 may be arranged through the inside of the second channel 26 of the second liquid supply tube 23 to reach the outlet 23a of the second liquid supply tube 23. The electrodes 215 and 315 can be arranged proximate to the outlets 22a and 23a, respectively, to an extent that ejection of the sample liquids Lf₁ and Lf₂ from the outlets 22a and 23a is not hindered. As a result, voltages can be applied to the sample liquid Lf₁ or Lf₂ for the duration of flowing through the respective channels, so that the sample liquid can be sufficiently electrically charged.

The electrode 415 may be arranged through the gas channel 28 of the gas supply tube 24 to reach the mixing zone 33 upstream of the porous member 31. As a result, droplets or mixed droplets of the sample liquid Lf₁ and Lf₂ generated in the mixing region 33 can be electrically charged.

Hereinafter, a variation of the sprayer according to the first embodiment of the present invention will be described. In the variation, configurations different from those of the nozzle 18 illustrated in FIGS. 2A and 2B will be described, and the same reference numerals as those in FIGS. 2A and 2B will be assigned to the same configurations, and descriptions thereof will be omitted. The same configurations omitting description achieve the same effects in the variation, in which description of the effects is omitted for the sake of simplicity.

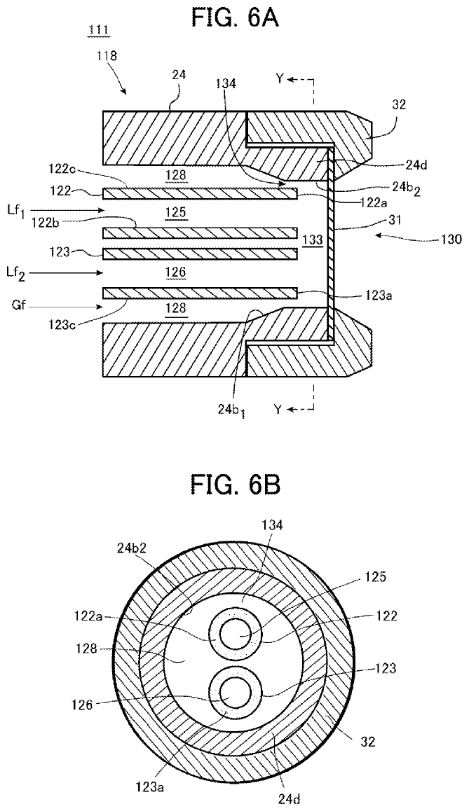

FIGS. 6A and 6B are cross-sectional views of the nozzle of the first variation of the sprayer according to the first embodiment of the present invention, in which FIG. 6A is an enlarged cross-sectional view along the longitudinal direction of sprayer, and FIG. 6B is a view along arrows Y-Y in FIG. 6A.

Referring to FIGS. 6A and 6B in conjunction with FIG. 1, the sprayer 111 includes: a first liquid supply tube 122; a second liquid supply tube 123 extending in parallel with the first liquid supply tube 122; a gas supply tube 24 surrounding the first liquid supply tube 122 and the second liquid supply tube 123; and the electrode 15 for applying high voltage to the sample liquid Lf₁ flowing through the first liquid supply tube 122. The electrode 15 has the same configuration as illustrated in FIGS. 1, 3A, 3B and 5.

The first liquid supply tube 122 has a configuration similar to that of the first liquid supply tube 122 illustrated in FIGS. 1, 2A and 2B. A tubular first channel 125 is defined on an inner circumferential surface 122b of the first liquid supply tube 122. The first liquid supply tube 122 includes an outlet 122a, in the nozzle 118. The second liquid supply tube 123 has a configuration similar to that of the first liquid supply tube 122, includes a tubular second channel 126, and includes an outlet 123a, in the nozzle 118.

The gas supply tube 24 has a configuration similar to that of the gas supply tube 24 illustrated in FIGS. 1, 2A and 2B. The gas channel 128 of the gas supply tube 24 is defined by the outer circumferential surfaces 122c and 123c of the first liquid supply tube 122 and the second liquid supply tube 123, and the inner circumferential surface 24b of the gas supply tube 24.

The spraying gas Gf flows through the gas channel 128. As illustrated in FIG. 6A, the channel area of the gas channel 128 preferably progressively decreases such that the diameter of the gas supply tube 24 progressively decreases in the portion 24b₁ of the inner circumferential surface from upstream toward downstream. A constriction portion 134 is preferably provided to the gas supply tube 24. The constriction portion 134 is formed between the portion 24b₁ of the inner circumferential surface of the gas supply tube 24 and a portion of the outer circumferential surfaces 122c and 123c of the first liquid supply tube 122 and the second liquid supply tube 123, and achieves the same operation and effects as the constriction portion 34 illustrated in FIGS. 2A and 2B.

The outlet 122a of the first liquid supply tube 122 and the outlet 123a of the second liquid supply tube 123 are arranged at substantially the same position in the ejection direction. A mixing region 133 for the sample liquids Lf₁ and Lf₂ and the spraying gas Gf is formed between the outlets 122a and 123a and the porous member 31, in which atomized and electrically charged mixed droplets are generated in the same manner as in the mixing region 33 illustrated in FIG. 2A. The electrically charged and atomized mixed droplets pass through the opening of the porous member 31 by way of the spraying gas Gf, and are ejected from the ejection port 130.

A liquid supply tube for supplying and mixing still another sample liquid may be added to the first liquid supply tube 122 and the second liquid supply tube 123. A third liquid supply tube may be provided in parallel with the second liquid supply tube 23 illustrated in FIGS. 2A and 2B.

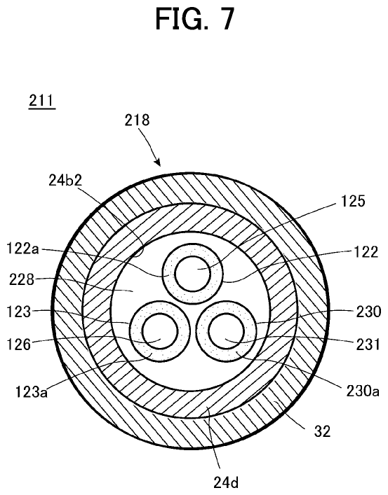

FIG. 7 is a cross-sectional view of the nozzle of the second variation of the sprayer according to the first embodiment, and is a cross-sectional view corresponding to FIG. 6B. Referring to FIG. 7, the sprayer 211 is provided with a third liquid supply tube 230 in parallel with the first liquid supply tube 122 and the second liquid supply tube 123. The sample liquid is ejected from each of the outlets 122a, 123a and 230a of the nozzle 218. The spraying gas Gf is ejected from the gas channel 228 to form a mixing region (not illustrated). Four or more liquid supply tubes may be provided.

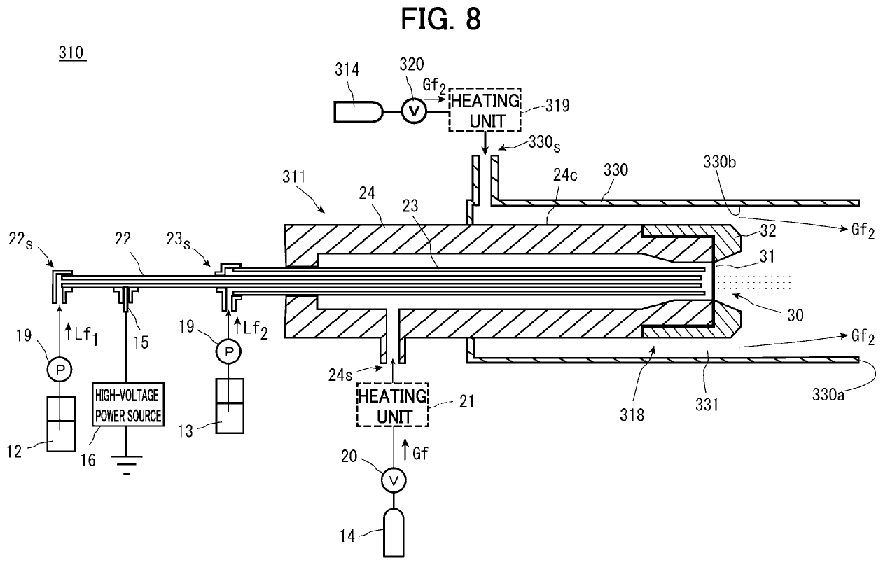

FIG. 8 is a diagram schematically illustrating a configuration of a spray ionization device according to a second embodiment of the present invention. Referring to FIG. 8, in the case of a spray ionization device 310, a sprayer 311 includes a second gas supply tube 330 surrounding the gas supply tube 24, and a nozzle 318 has the same configuration as the nozzle 18 illustrated in FIGS. 2A and 2B. Sheath gas Gf₂ is supplied from a cylinder 314 via a valve 320 to a supply port 330s of a second gas supply tube 330.

The second gas supply tube 330 includes a gas channel 331. The gas channel 331 is defined by the outer circumferential surface 24c of the gas supply tube 24 and an inner circumferential surface 330b of the second gas supply tube 330, and extends in the ejection direction. The inner circumferential surface 330b of the second gas supply tube 330 has a constant diameter toward the outlet 330a. The flow of the sheath gas Gf₂ flowing through the gas channel 331 is restricted from spreading by the inner circumferential surface 330b of the second gas supply tube 330 toward the outlet 330a. The electrically charged mixed droplets ejected from the nozzle 318 are enveloped in the sheath gas Gf₂. As a result, the electrically charged mixed droplets are ejected from the outlet 330a of the second gas supply tube 330 along the ejection direction. With such a configuration, the sprayer 311 can eject focused and electrically charged mixed droplets.

A heating unit 319 may be provided downstream of the valve 320 so as to supply the sheath gas Gf₂ as heated gas. A heating unit such as a ring-heater (not illustrated) may be provided downstream of the retaining member 32 of the gas supply tube 24 so as to surround the second gas supply tube 330. As a result, desolvation of droplets can be supported.

The sprayer 311 can employ the sprayer 111 having the configuration illustrated in FIGS. 6A and 6B and the sprayer 211 having the configuration illustrated in FIG. 7, in which the same effects can be achieved.

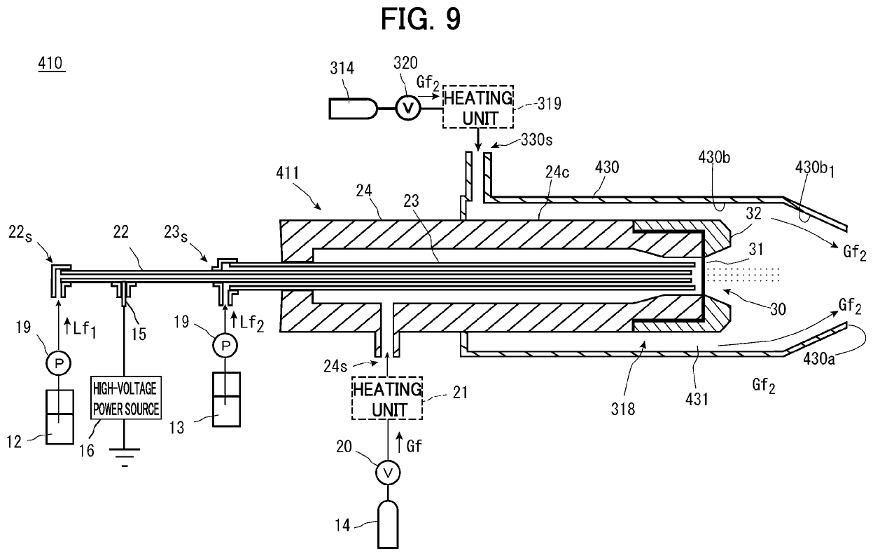

FIG. 9 is a diagram schematically illustrating a configuration of a spray ionization device according to a third embodiment of the present invention. Referring to FIG. 9, a sprayer 411 of a spray ionization device 410 includes a second gas supply tube 430. The second gas supply tube 430 has the same configuration as the second gas supply tube 330, except that the tip shape of the second gas supply tube 430 differs from the tip shape of the second 330 illustrated in FIG. 8. The second gas supply tube 430 is formed so as to have a diameter that progressively decreases in a portion 430b₁ of the inner circumferential surface toward the outlet 430a. Accordingly, the channel area of the gas channel 431 progressively decreases.

The sheath gas Gf₂ flowing through the gas channel 431 flows toward the outlet 430a such that the flow focuses while being restricted by the inner circumferential surface 430b of the second gas supply tube 430. The electrically charged mixed droplets ejected from the nozzle 318 are enveloped in the sheath gas Gf₂ and focus onto the axial center along the ejection direction. As a result, the focused and electrically charged mixed droplets are ejected from the outlet 430a of the second gas supply tube 430. With this configuration, even if the nozzle 318 cannot eject electrically charged droplets with sufficient focusing thereof, the sprayer 411 can focus and eject droplets.

### [Analysis Device]

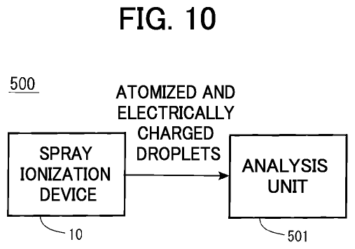

FIG. 10 is a diagram schematically illustrating a configuration of an analysis device according to an embodiment of the present invention. Referring to FIG. 10, an analysis device 500 includes a spray ionization device 10 and an analysis unit 501 for introducing atomized and electrically charged mixed droplets from the spray ionization device 10 and performing mass spectrometry or the like.

The spray ionization device 10 can be applied to the first and second variations of the first embodiment and the spray ionization device of the second and third embodiments. The spray ionization device 10 sends the electrically charged mixed droplets, which have been atomized by ejecting a plurality of sample liquids, to the analysis unit 501. The atomized and electrically charged mixed droplets are introduced into the analysis unit 501 in a state in which the molecules, clusters, and the like of components contained in the droplets are electrically charged by evaporation of solvents.

In the case in which the analysis unit 501 is a mass spectrometer, the analysis unit 501 includes, for example, an ion lens, a quadrupole mass filter, and a detection unit (all not illustrated). The ion les focuses ions of the components of the mixed droplets generated by the spray ionization device 10, and the quadrupole mass filter separates out specific ions based on a mass-to-charge ratio. The detection unit detects the specific ions for each mass number, and outputs detection signals.

The spray ionization device 10 efficiently generates ions of components of the droplets, in which sample liquids Lf₁ and Lf₂ are mixed, and can therefore be used as an ion source of trace components. The analysis device 500 is, for example, a liquid chromatography-mass spectrometry (LC/MS) device including the spray ionization device 10 as an ion source.

Hereinafter, Measurement Examples using Examples of the spray ionization devices according to the embodiments of the present invention will be described. As a Comparative Example, an ESI ion source using a gas spray assisted electrospray ionization (ESI) method was used.

Example 1 is the spray ionization device of the first embodiment illustrated in FIGS. 1, 2A and 2B, in which the electrode 15 is arranged at the supply port 23ₛ of the second liquid supply tube 23 and contacts the sample liquid Lf₂. The first liquid supply tube 22 is made of fused silica glass, the second liquid supply tube 23 is made of PEEK resin, the first liquid supply tube 22 has an inner diameter of 50 μm and an outer diameter of 150 μm, the second liquid supply tube 23 has an inner diameter of 250 μm and an outer diameter of 350 μm, the gas supply tube 24 has an inner diameter of 4000 μm, and each aperture of the porous member 31 (made of PEEK resin) has a vertical and horizontal size of 35 μm.

Example 2 is the spray ionization device of the first embodiment illustrated in FIGS. 1, 2A and FIG. 2B, in which the electrode 15 is made of stainless steel (SUS316) and provided to the first liquid supply tube 22, and high voltage is applied to the sample liquid Lf₁ flowing through the first liquid supply tube 22 and the sample liquid Lf₂ flowing through the second liquid supply tube 23, over the entire longitudinal direction of the first liquid supply tube 22. The first liquid supply tube 22 has an inner diameter of 50 μm and an outer diameter of 320 μm, the second liquid supply tube 23 has an inner diameter of 530 μm and an outer diameter of 700 μm, and the gas supply tube 24 and the porous member 31 are the same as in the first embodiment.

A sprayer (ESI-probe (ion source)) attached to model API2000, a mass spectrometer manufactured by AB SCIEX, U.S.A. was used in the Comparative Example 1. The ESI-probe of Comparative Example 1 has a structure in which only a single sample liquid is supplied to a sprayer. The sample liquids Lf₁ and Lf₂ were mixed by a T-connector upstream of the sprayer, and a solution of the sample liquids was supplied into the single sprayer, electrically charged, and sprayed.

### Measurement Example 1: Peak Intensity of Deoxyadenosine Monophosphate (dAMP) Solution (at the Spraying Gas Temperature of 25° C.)

A mixed liquid (hereinafter, also referred to as “dAMP mixed liquid”) composed of an aqueous deoxyadenosine monophosphate (dAMP) solution (50 ppm concentration) separated by liquid chromatograph and ammonium formate (pH 3) having concentration of 10 mM as a solvent was supplied as a sample solution Lf₂ to the second liquid supply tube 23 of Examples 1 and 2. The flow rate was 25 μL/min.

An aqueous ammoniacal solution for pH-adjustment (abbreviated as “NH₃”) (pH 11) was supplied as a sample solution Lf₁ to the first liquid supply tube 22 of Examples 1 and 2. The flow rate was 25 μL/min. In Measurement Example 1, in the case of separating dAMP by liquid chromatography, if other nucleotides were present in the sample, dAMP was separated in a low-pH solution and dissociated in the neutral region by a mass spectrometer to expect increase in dAMP sensitivity.

In the ESI-probe of Comparative Example 1, the sample solution Lf₁ and Lf₂ were mixed by the T-connector at the base of the sprayer. The flow rate of the sample solution Lf₁ and Lf₂ was 25 μL/min. Nitrogen gas at 25° C. was used for the spraying gas Gf in Examples 1 and 2 and Comparative Example 1. The gas flow rate was 2 L/min in Examples 1 and 2, and at a set value of 18 as a recommended value of the manufacturer of the mass spectrometer in Comparative Example 1.

In Examples 1 and 2, a high-voltage power source (manufactured by AB SCIEX, Model API2000 equipment) was connected to the electrode, in which DC voltage of 4.5 kV was applied to the sample solution Lf₂ in Example 1, and applied to the sample solution Lf₁ and Lf₂ by the first liquid supply tube 22 made of stainless steel in Example 2. In Comparative Example 1, DC voltage of 4.5 kV was applied to a sample solution in which the sample solution Lf₁ and Lf₂ were mixed.

Model LC-10Avp manufactured by Shimadzu Corporation was used for the liquid chromatograph, and Model API 2000 manufactured by AB SCIEX (LC/MS/MS (method of detecting a specific m/z (mass-to-charge ratio) by coupling a mass spectrometer to a liquid chromatograph)) was used for the mass spectrometer, in which signal intensity of the mass chromatogram of m/z=329.604 was measured.

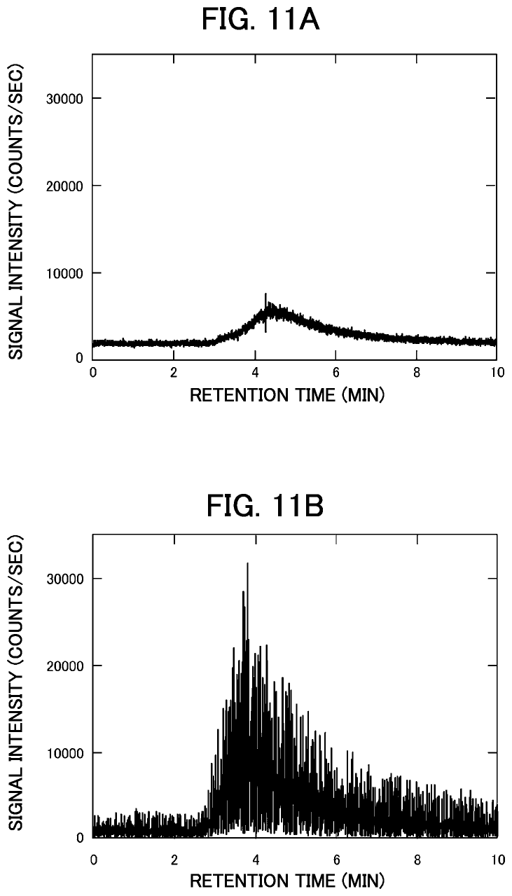

FIG. 11A is a diagram illustrating an example of the mass chromatogram of Example 1, and FIG. 11B is a diagram illustrating an example of the mass chromatogram of Comparative Example 1. In FIGS. 11A and 11B, the horizontal axis represents the retention time (minutes) of the mass chromatogram, and the vertical axis represents the signal intensity (counts).

Referring to FIGS. 11A and 11B, in the mass chromatogram of Example 1, the back noise is much more stable than that of Comparative Example 1, and a peak clearly appears. This shows that dAMP was more stably ionized in Example 1 than in Comparative Example 1.

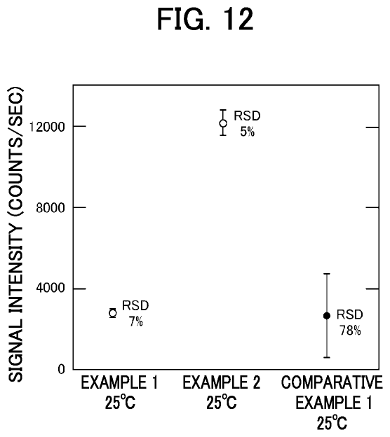

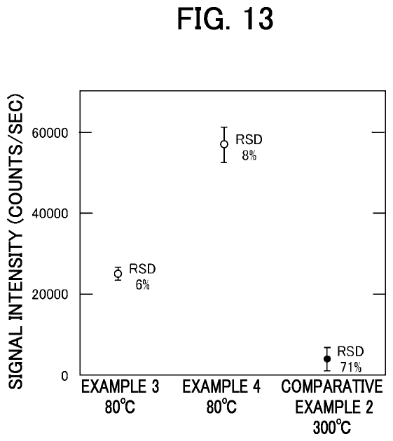

FIG. 12 is a diagram illustrating another Measurement Example of signal intensity of Examples 1 and 2 and Comparative Example 1. The signal intensity on the vertical axis of FIG. 12 was determined from the average value and the standard deviation of signal intensity for six seconds near the peak top, in which the average values are indicated by circles, the standard deviation is indicated by an error bar, and RSD was indicated as a relative standard deviation (%) (=average value/standard deviation×100). The signal intensity of FIG. 13 was also determined in the same manner.

Referring to FIG. 12, when Example 1 is compared with Comparative Example 1, the average value of the signal intensity is substantially equivalent; however, the relative standard deviation is extremely small as about 1/11 in Example 1. It was found that the variation in signal intensity was more suppressed and the signal intensity was more stable in Example 1 than in Comparative Example 1. As a result, it was found that the spray ionization device of the first embodiment can stably obtain electrically charged droplets, in which the dAMP mixed solution and NH₃ are uniformly mixed. The average value of the signal intensity in Example 2 is 4.6 times that in Comparative Example 1, and 4.3 times that in Example 1, revealing that Example 2 can perform ionization extremely efficiently. It can be inferred that this is achieved by the spray ionization device of the second embodiment which applies high voltage to the dAMP mixed solution and NH₃ over the entire length of the first liquid supply tube 22.

### Measurement Example 2: Signal Intensity of Deoxyadenosine Monophosphate (dAMP) Solution (in the Case of Heating the Sheath Gas)

Example 3 mimics an aspect, in which the sprayer of Example 1 is applied to the sprayer having the second gas supply tube 330 illustrated in FIG. 8, and in which the sheath gas Gf₂ heated to 80° C. by a heater was supplied downstream surrounding the flow of the mixed droplets ejected from the ejection port 30. In Example 4, the sheath gas Gf₂ at 80° C. was supplied to the sprayer of Example 2 in a similar manner. Examples 3 and 4 are the same as Examples 1 and 2, except for the above conditions. In Comparative Example 2, the spraying gas was supplied by setting the temperature to 300° C., using the heated gas nozzle of the sprayer attached to the mass spectrometer. Other conditions were the same as those in Measurement Example 1.

FIG. 13 is a diagram illustrating Measurement Example of the signal intensity in Examples 3 and 4 and Comparative Example 2. Referring to FIG. 13, the average value of the signal intensity in Example 3 was six times the average value of the signal intensity in Comparative Example 2, revealing that ionization can be performed extremely efficiently in Example 3. In Example 3, the relative standard deviation of the signal intensity was 6%, and it was found that electrically charged droplets can be stably obtained, in which the dAMP mixed solution and NH₃ are uniformly mixed.

The average value of the signal intensity in Example 4 was 2.3 times the average value of the signal intensity in Example 3, revealing that ionization can be performed extremely efficiently in Example 4 as in the case of Example 2.

In the foregoing, the preferred embodiments of the present invention have been described in detail; however, the present invention is not limited to the specific embodiments, and various modifications and changes can be made within the scope of the present invention described in the claims.

The shape of the cross-section and the channel of the liquid supply tube has been described as circular, but may be triangular, square, pentagonal, hexagonal or other polygonal shapes, or other shapes such as an elliptical shape. The shape of the outer circumferential surface and the inner circumferential surface of the gas supply tube and the second gas supply tube can be selected from these shapes, depending on the shape of the liquid supply tube.

The spray ionization device of the present invention can be used as an ion source of various devices; for example, in the field of trace sample analysis, the spray ionization device can be used for mass spectrometry such as mass spectrometry of molecules in a biological sample, elemental analysis, chemical morphology analysis, and charged particle analysis.

In the field of surface treatment and granulation, the spray ionization device of the present invention can be used for surface coating devices utilizing surface coating techniques of spraying electrically charged droplets, and particle forming devices utilizing particle forming techniques by spraying electrically charged droplets of suspension.

In the field of food production, healthcare, and agriculture, the spray ionization device of the present invention can be used for space processing devices utilizing sterilization, deodorization, dust collection, and chemical reactions, utilizing gas-phase or spatial chemical reactions by spraying electrically charged droplets.

### EXPLANATION OF REFERENCE NUMERALS

10, 310, 410: spray ionization device
11, 111, 211, 311, 411: sprayer
12, 13: container
14, 314: cylinder
15, 115, 215, 315, 415: electrode
16: high-voltage power source
18, 118, 218, 318: nozzle
21, 319: heating unit
22, 122, 222: first liquid supply tube
23, 123, 223: second liquid supply tube
24: gas supply tube
30: ejection port
31: porous member
32: retaining member
330, 430: second gas supply tube
500: analysis device
501: analysis unit
Lf₁, Lf₂: sample liquid
Gf: spraying gas
Gf2: sheath gas

1. A spray ionization device, comprising:
a first tube including a first channel through which a first liquid can flow, the first tube including a first outlet for ejecting the first liquid at one end;
a second tube including a second channel through which a second liquid can flow, the second tube including a second outlet for ejecting the second liquid at the one end;
an outer tube including the first tube and the second tube, the outer tube surrounding an outer circumferential surface of at least one of the first tube and the second tube with a gap, the outer tube including a gas channel through which a gas can flow, the outer tube including an ejection port covered with a porous member at a distance downstream of the first outlet and the second outlet at the one end; and
an electrode arranged between the first channel, the second channel and the first outlet, and the porous member, or between the first channel, the second channel and the second outlet, and the porous member, the electrode being capable of applying voltage to at least one of the first liquid and the second liquid by a power source connected to the electrode, wherein
charged droplets generated by mixing the first liquid and the second liquid together with the gas can be ejected from the ejection port.

2. The spray ionization device according to claim 1, wherein the second tube surrounds the first tube with a gap, and the second channel is defined by an outer circumferential surface of the first tube and an inner circumferential surface of the second tube.

3. The spray ionization device according to claim 2, wherein the second outlet is provided at the same position as, or downstream of, the first outlet.

4. The spray ionization device according to claim 3, wherein a distance between the second outlet and the first outlet is set to 0 μm or more and 1000 μm or less in an ejection direction.

5. The spray ionization device according to claim 2, wherein the electrode is the first tube formed of an electrical conductor material, and the power source is connected to the first tube.

6. The spray ionization device according to claim 1, wherein the first tube and the second tube are arranged in parallel in the gas channel.

7. The spray ionization device according to claim 6, wherein a plurality of the first tube(s) and the second tube(s) are provided, respectively, and arranged in parallel in the gas channel.

8. The spray ionization device according to claim 1, further comprising: a third tube including a third channel through which a third liquid can flow, the third tube including a third outlet for ejecting the third liquid at the one end.

9. The spray ionization device according to claim 8, wherein the third tube is arranged in parallel with the first tube and the second tube in the gas channel.

10. The spray ionization device according to claim 1, wherein the gas channel includes a constriction portion arranged further toward an opposite end than the first outlet and the second outlet, the constriction portion configured to have a channel area progressively decreasing from the opposite end to the constriction portion.

11. The spray ionization device according to claim 1, further comprising:
a high-voltage power source connected to the electrode, wherein
the high-voltage power source applies voltage in a range of 0.5 kV to 10.0 kV to the electrode.

12. The spray ionization device according to claim 1, further comprising: a second outer tube surrounding the outer tube with a gap and including a second gas channel through which a second gas can flow, the second outer tube including a third outlet downstream of the ejection port at the one end, the second gas channel being defined by an outer circumferential surface of the outer tube and an inner circumferential surface of the second outer tube.

13. The spray ionization device according to claim 12, wherein the second outer tube has a diameter that at least progressively decreases in the inner circumferential surface toward the third outlet, at the one end.

14. The spray ionization device according to claim 12, further comprising: a second heating unit for heating the second gas or electrically charged droplets ejected from the ejection port together with the second gas enveloping the electrically charged droplets.

15. An analysis device, comprising:
the spray ionization device according to claim 1; and
an analysis unit that introduces and analyzes the electrically charged droplets sprayed from the spray ionization device.

16. A surface coating device comprising the spray ionization device according to claim 1.
